(19) United States
(12) Patent Application Publication
(10) Pub. No.: US 2004/0073502 A1
(43) Pub. Date: Apr. 15, 2004

(54) Multi-party negotiations with multiple attributes

(76) Inventors: Aseem Agrawal, New Delhi (IN); Vipul Bansal, New Delhi (IN); Varun Sagar Malhotra, New Delhi (IN)

Correspondence Address: T. Rao Coca, IBM Corporation, Almaden Research Center, 650 Harry Road, San Jose, CA, 95120, US

(21) Appl. No.: 10/267,475

(22) Filed: Oct. 9, 2002

(51) Int. Cl. G06F 17/60

(52) U.S. Cl. 705/35

(57) ABSTRACT

This invention relates to a method, system and computer program product for enabling negotiations for resolution of e-commerce transactions involving direct interactions between an offering party (seller or buyer) and a counterparty (buyer or seller). The invention includes generating a public offer containing values of a defined set of attributes by a party to the target population of the counterparties and sending private acknowledgements of acceptance or responses containing counter offers for at least one of the offers to at least one party.

### BACKGROUND OF THE INVENTION

1. Field of the Invention

The present invention relates to the field of electronic commerce. In particular, it relates to the field of online negotiations involving multiple attributes conducted between multiple buyers and sellers at the same time.

2. Background of the Invention

The advent of online commerce has seen the emergence of a large number of ways by which the buyers and sellers can arrive at mutually agreeable terms for transacting goods and services. This may be accomplished through a variety of means, for example, catalogue sales, competitive bidding, exchanges and one-on-one negotiations.

One-on-one (two-party and multi-party) negotiations are expected to grow in popularity as they are closer to the way businesses currently operate. One would also expect the negotiations to involve multiple attributes rather than just price and quantity.

When multiple buyers and sellers wish to transact similar but differentiated items online, the sellers can use posted price sales, publicly auction their goods or engage in private one-to-one negotiations with potential buyers.

In posted price sales, buyers have to take or leave the offer and there is no room for negotiation. In auctions, at most one of the two engaging counterparties (buyer or seller) can make active moves. For example, in a Dutch auction, the seller can reduce the offer price; in open outcry auctions, the bidders make higher counterbids; and in sealed bid auctions, no one actively negotiates. More importantly, the auction mechanisms do not permit the bids or offers to capture the multi-attributed nature of the goods being transacted, restricting flexibility to just price and quantity. The items are typically fixed and their characteristics cannot be negotiated.

Private one-on-one negotiations are not practical when a large number of buyers and sellers are simultaneously involved. Such a method requires considerable effort on the part of the participants due to the need to engage in multiple independent negotiations. This limits the number of parties one can negotiate with. Moreover, whenever a participant reaches an agreement and transacts with someone, it may withdraw from the ongoing negotiations with the others. This results in a lot of aborted negotiation activities, thereby diluting the confidence of participants in the mechanism. If each participant were to independently decide on which positions to withdraw in case of overcommitment, then the outcomes may not have any desirable economic properties. On the other hand, mechanisms for centralized resolution of overcommitment may be difficult to enforce for resolving ties in a setup of private independent negotiations.

When buyers and sellers exchange positions on multiple attributes, the relative weightages they might wish to assign to different attributes can in general differ for various participants and may even be private to them. As a result, there can be different sets of attribute values of an item which might have the same value/utility to a party (say the seller), but which might be valued differently by various counterparties (buyers). In this case, the seller faces the problem of choosing the sets of attribute values to offer to different buyers so that it can reach mutually acceptable deals with at least one of them at the earliest.

Significant amount of work has taken place in the last few years in the area of providing means for negotiations between multiple counterparties in various forms and this is reflected in the existing e-commerce web sites as well as the patents that exist in this area.

WO 01/57618 relates to a system for multi-dimensional e-commerce auctions. It provides a computerized system for facilitating multidimensional auctions based upon buyer defined parameters. In this system a list of offers is generated based upon buyer's request, a scoring function and the set of offerings. However in this system the seller's offers are auto-generated based upon the seller data and offers fed initially into the computer system. Hence this system is not suitable in situations where one to one negotiations and direct interaction between the sellers and the buyers is desired.

U.S. Pat. No. 6,141,653 describes a system for enabling and processing multivariate negotiations. However, it only describes a framework and does not provide a mechanism for implementing negotiations.

U.S. Pat. No. 5,495,412 describes a computer-based method where buyers and sellers submit multi-attributed positions to a centralized intermediary that applies optimization techniques for obtaining outcomes that maximize the individual and overall benefits to the parties. This technique requires an intermediary agency for the negotiations.

Similarly, U.S. Pat. No. 6,112,189 describes a method for automating negotiation between multiple parties by introducing an intermediary that accepts utility function from each party, and then attempts to maximize their mutual satisfaction.

U.S. Pat. No. 5,924,082 describes a system used by an intermediary for identifying potential counterparties to a transaction and enabling communication between the parties to negotiate the terms of the transaction.

U.S. Pat. No. 6,154,778 describes a method used by an intermediary agency for negotiating a multi-category quality-of-service (QoS) agreement between a client and a server in a system. However, this is a one-step negotiation and a client cannot propose alternative offer.

The disadvantage with the above-mentioned methods is that they do not provide decentralized methods and systems for negotiations between multiple parties.

The above inventions also do not provide any solution for the specific problems identified above in the case of multiple attributes.

### SUMMARY OF THE INVENTION

To overcome the above drawbacks the invention provides for a method and a computer-implemented system that allows buyers and sellers to direct and simultaneously negotiate e-commerce transactions with multiple counterparties.

The second object of the invention is to facilitate negotiating on multiple attributes in the same or different online markets.

These and other objects are achieved by providing a method for conducting direct negotiations by enabling each party offering or seeking the products or services, to simultaneously generate public offers defining the attributes of the products or services to the target population of counterparties, following which any of the counterparties may then respond privately to a party by generating an acceptance to an offer or by generating a counter offer. In the event of receiving counter offers, the offering party may choose to accept the counter offers and/or instead, generate revised public offers to all the counterparties. This cycle of offers and counter offers repeats as long as any of the parties or counterparties desires to do so.

Each offer and counter offer may define multiple attributes of the offered products or services. A party may accept a counter offer even if it is inferior to the offer made by it.

Any party or counterparty may generate and distribute multiple offers and counter offers simultaneously.

The invention also defines a system for conducting direct negotiations by providing Offer Generating Means for parties to simultaneously generate public offers defining the attributes of the products or services to a target population of counterparties. In addition, the invention provides Offer Accepting Means for enabling counterparties to generate private acceptances to suitable offers and also provided are Counter Offer Generating Means for counterparties to generate private counter offers where necessary. The offering party may choose to accept the counter offers and/or generate revised public offers to all the counterparties. The cycle of offers and counter offers repeats as long as any of the parties or counterparties desires to do so.

The invention also defines a computer program product for implementing the aforementioned method for conducting direct negotiations over a network.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative preferred embodiment when read in conjunction with the accompanying drawings, wherein:

FIG. 1 is a general block diagram of a system incorporating the invention

FIG. 2 is a general block diagram of one of the nodes of the system.

FIG. 3 is a flowchart of the invention as applied to an auction process.

### DETAILED DESCRIPTION

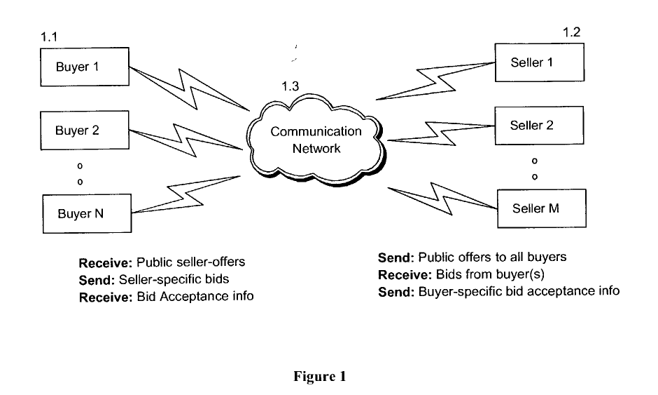

FIG. 1 depicts a general block diagram of a system incorporating the invention. A potential buyer (1.1) is interconnected to a potential seller (1.2) through the use of communication network (1.3). The communication network which could be any form of public or private network, including networks using protocols such as X.25, Ethernet, TCP/IP, is the medium used to provide communications links between various devices and computers which the buyers and sellers may use to connect together within the system. The network may include connections, such as wire, wireless communication links, or fiber optic cables.

The nodes labeled as buyers (1.1) and sellers (1.2) could be electronic devices like personal computers, mobile phones, interactive televisions and the like, being operated by humans or they could also be software agents running on electronic devices on behalf of individuals or organizations. The participants on each side (buyers or sellers) have some means for public dissemination of information related to the ongoing negotiations to the other side. This could be achieved with the help of a web site hosted using the HTTP protocol, maintaining a list of buyers and providing electronic messaging services using email, instant messaging etc. or it could also be facilitated with the help of an intermediary that functions solely for facilitating such information, either using a web site or any other electronic communication means.

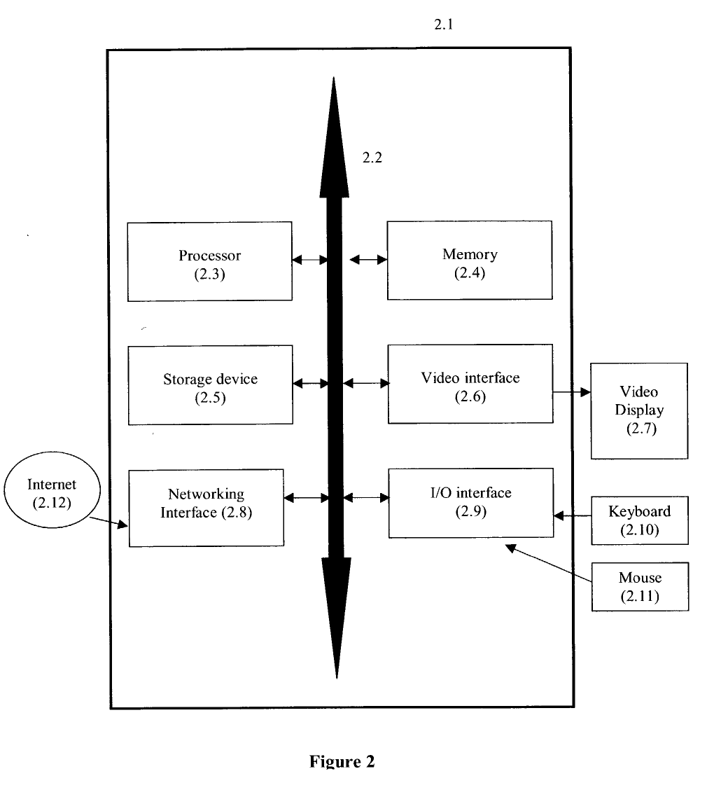

FIG. 2 is a block diagram that illustrates a typical device incorporating the invention. The device (2.1) consists of various subsystems interconnected with the help of a system bus (2.2). Each device (2.1) incorporates a storage device (2.5) that is used to store the offer generating means, offer accepting means and counter offer generating means used in the invention. Both the buyer and the seller use the device to generate and accept offer(s)/couteroffer(s) as the case may be. The offer generating means generate at least one offer and disseminating these simultaneously to a defined set of target nodes, offer accepting means generate private acceptances to an offer and while counter offer generating means generate responses to received offers either automatically or under manual control.

Those of ordinary skill in the art will appreciate that the offer generating means, offer accepting means and counter offer generating means are instructions for operating on the nodes of the system. The means are capable of existing in an embedded form within the hardware of the node or may be embodied on various computer readable media. The computer readable media may take the form of coded formats that are decoded for actual use in a particular information processing system. Computer program means or a computer program in the present context mean any expression, in any language, code, or notation, of a set of instructions intended to cause a system having information processing capability to perform the particular function either directly or after performing either or both of the following:

a) conversion to another language, code or notation

b) reproduction in a different material form.

At the seller side, the instructions encoded in the offer generating means are transferred from the storage device (2.5) to the memory, which holds the current instructions to be executed by the processor along with their results, through the internal communication bus (2.2). The processor (2.3) executes the instructions by fetching them from the memory (2.4) to generate a public offer. The processor (2.3) could be a microprocessor in case of a PC, a dedicated semiconductor chip and the like. During the execution of the means, the keyboard (2.10), mouse (2.11) and other input devices connected to the computer system through the I/O interface (2.9) are used to enter the details of the offers.

Each of the aforementioned means is either individually or collectively connected to a messaging system such as email system that uses the networking interface (2.8) for disseminating information to the target nodes over a network such as the Internet (2.12). The messaging system may exist as a standard system used by various client systems such as the offer generating means, offer accepting means and counter offer generating means or the messaging system may be integrated with these means and implemented as a standalone system. Therefore, after the generation of the offer it is sent to the prospective buyers over the Internet (2.12) using the networking interface (2.8).

At the buyer side, the offer is received from the Internet (2.12) through the networking interface (2.8). The details of the offer are displayed to the buyer using the video display (2.7) connected to the computer through the video interface (2.6). The seller analyzes the offer and compare it to other offers received to select the most suitable proposition.

All the offer data received over the network by the seller is stored on the storage device (2.5) of the seller's computer and transferred to the memory (2.4) when required by the counteroffer generating means during execution.

The seller uses the offer accepting means stored on the storage device (2.5) to generate a private acknowledgement to an offer or to generate a counter offer. The instructions of the offer accepting means are transferred to the memory (2.4) through the system bus (2.2) to be executed by the processor (2.3). The buyer enters the details of the acceptance or counteroffer using an input device such as keyboard (2.10) and mouse (2.11) connected to the computer through the I/O interface (2.9). The acceptance or the counteroffer generated is sent to the seller through the Internet (2.12) using the networking interface (2.8).

The aforementioned means may interface with a database to store and retrieve the details required for generating and accepting offers and counter offers. The said database may reside on the same system on which the means are stored and executed or it maybe located on a different system connected to the network.

As a preferred embodiment, the offer generating means, offer accepting means and counter offer generating means may exist as separate entities but they may also be combined in any form as groups or as a single entity. Other variations to the implementation of the said means may have a node containing only a subset of the three means, for instance, a node can provide only an offer generating mean without having any provision for the offer acceptance or counter offer generating mean. Similarly, it is possible to have an incorporating device that is incapable of generating any offers, but can accept or generate counter offers to a received offer.

The depicted example in FIG. 2 is not meant to imply architectural limitations and the configuration of the incorporating device of the said means may vary depending on the implementation. The invention can be realized in hardware, software, or a combination of hardware and software. Any kind of computer system or other apparatus adapted for carrying out the means described herein can be employed for practicing the invention. A typical combination of hardware and software could be a general purpose computer system with a computer program that when loaded and executed, controls the computer system such that it carries out the means described herein.

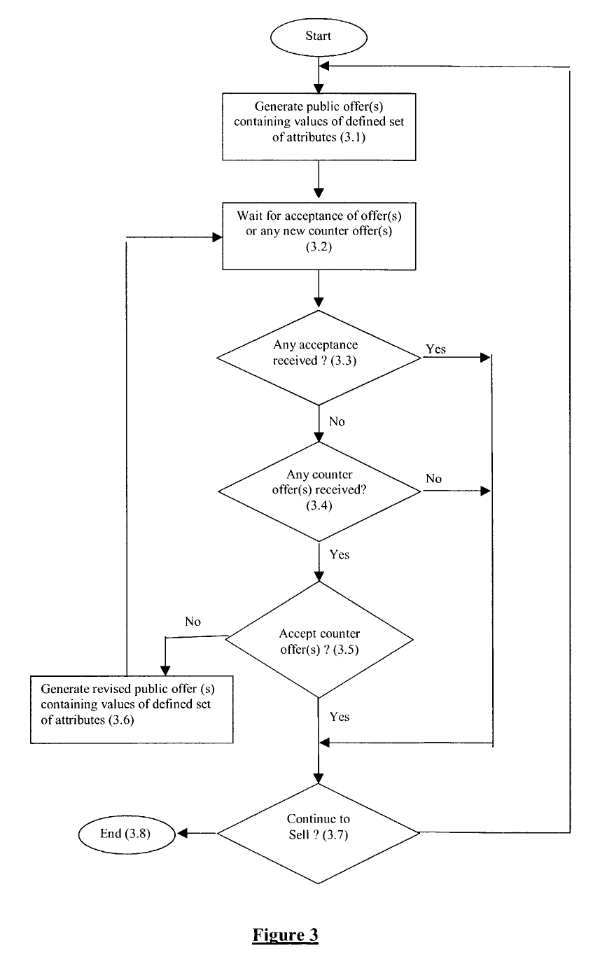

FIG. 3 shows a flowchart of the invention as applied to the case of an auction. The sellers use the offer generating means to generate a public offer (3.1) to initiate the process. Each offer from a seller is a vector containing values of at least one attribute on which the seller is willing to negotiate. For example, if the item being sold is a PC, the attributes may be memory, clock speed and price. For steel, they may be tensile strength and price. Different offers from the same seller represent different such combinations of attribute values and may relate to the same underlying units being offered by the seller. Though the seller is indifferent to these offers, a given buyer may value the different offers differently. In the example of PCs, a seller may make 2 offers, (Memory=32 MB, Clock speed=600 MHz, Price=USD1000) and (Memory=64 MB, Clock speed=400 MHz, Price=USD1100).

A buyer round follows the initiation of the negotiations by the sellers and subsequently alternates with seller rounds. During this period the sellers wait for an acceptance of the public offer or a new seller specific counter offer from a prospective buyer (3.2). The buyer may be indifferent to the counteroffer. A counteroffer is similar in structure to the corresponding offer in response to which it is placed—it is a vector of the buyer-specified values of the attributes specified in the offer. A counteroffer is binding on the buyer if accepted. However, a seller who gets multiple counteroffers from a buyer can accept at most one bid or a buyer-specified number of counteroffers or any number of counteroffers such that the total quantity does not exceed a buyer-specified quantity.

In the seller round at the end of the wait period, seller checks if any private acknowledgements generated by the offer accepting means at the buyer side have been received (3.3). If an acceptance has been received, then the seller decides whether to continue to sell or not (3.7). The seller further checks if any counteroffers generated by the offer accepting means at the buyer side have been received (3.4). The seller then checks if amongst the counteroffers received whether there are any counteroffers that are attribute-wise same or better for it than any of its offers to decide whether to accept any of the counteroffers to received (3.4). All counteroffers satisfying the seller's criterion of selection are accepted if the total quantity demanded does not exceed the quantity offered for sale (3.5) using the counter offer generating means (subject to any restrictions that may have been placed by the buyers). If the aggregate quantity demanded in such counteroffers is greater than the number of units a seller wishes to sell, then he/she is free to choose which of the counteroffers to accept. The seller then evaluates the remaining counteroffers that are not attribute-wise same or better than any offer made by the seller. The seller is free to accept or reject any of them and need not reveal them in public (3.5).

The seller now decides whether to continue to sell (3.7). If the negotiations continue, the sellers can now generate revised public offers using the counter offer generating means for subsequent buyer rounds (3.8). A seller may choose to supersede any of his offers with another offer, which is attribute-wise the same or better, for the buyers or add new offers to the already existing list of offers. In this way, sellers can progressively make better offers for buyers if they cannot clear their supply with existing offers. The seller also declare the number of units to sell and wait for bids from the buyers. A buyer round now follows as described earlier and the negotiations continue.

A seller quits the negotiations either on selling all the units or on deciding to discontinue selling in the absence of any bids. Similarly, a buyer may quit on obtaining the items it wishes to buy or on deciding to discontinue bidding due to rejection of bids by the sellers.

A proposal from a buyer/seller can consist of multiple simultaneous bids/offers to which the proposing buyer/seller is indifferent (the bids/offers in a proposal are vectors, each specifying a set of values for the attributes being negotiated, and could even be for an aggregate quantity greater than what the buyer/seller intends to buy/sell) and the counterparty receiving the proposal can respond to any number of the bids/offers contained therein with a bid/offer.

The offers contained in a seller's proposal are public offers open to all buyers while a buyer's proposal is private (seller-specific and not revealed to other buyers or sellers).

Within the same feature, the bids in a buyer's counter proposal to a seller could be inferior, same or superior compared to any of the offers in the seller's proposal and the seller may even accept bids which are inferior to any or all of its offers on its discretion.

The description of the present invention has been presented for purposes of illustration and description, and is not intended to be exhaustive or limited to the invention in the form disclosed. Many modifications and variations will be apparent to those of ordinary skill in the art. It may be noted that the mechanism described above in terms of rounds can also be made to operate asynchronously without requiring distinct buyer and seller rounds. In such a case, each offer and bid may be qualified with a time horizon over which it would be valid. The foregoing description with alternate rounds was provided to facilitate an understanding of the process.

It may be further noted that the above description applies to a situation where sellers make public offers and buyers place seller-specific bids. It is easy to see that the roles of buyers and sellers can be easily reversed with the buyers making public bids and the sellers responding by buyer-specific offers.

This invention reduces to special cases as follows:

Sealed Bid Auction

If a seller sets its initial offer high (so that it only receives lower bids) and it accepts the highest k bids received where it has k units to sell

Dutch Auction

If the bidders always bid equal to or less than a seller offer, and the seller does not accept any bid below its offer

The embodiment was chosen and described in order to best explain the principles of the invention, the practical application, and to enable others of ordinary skill in the art to understand the invention for various embodiments with various modifications as are suited to the particular use contemplated.

That which is claimed is:

1. A method for enabling negotiations for resolution of e-commerce transactions involving direct interactions between an offering party (seller or buyer) and a counterparty (buyer or seller), comprising the steps of:
generating public offer containing values of a defined set of attributes by the offering party to the target population of the counterparties,
sending private acknowledgements of acceptance or responses containing counter offers for the offer to the offering party, by a counterparty wherever desired, and
accepting a counter offer and/or generating a revised public offer wherever necessary by the offering party or the counterparty.

2. The method as claimed in claim 1 further comprising the step of continuing the sequence of formulating private responses containing acceptances or counter offers and accepting or generating modified public offers for each case as long as the offering party and counterparty to the case wish to continue doing so.

3. The method as claimed in claim 1 wherein said set of attributes contains multiple attributes.

4. The method as claimed in claim 1 wherein values of different attributes in the accepted responses could be inferior to, the same as or superior to those made in the offers.

5. The method as claimed in claim 1 wherein an offering party accepts responses inferior to its offers if the offering party does not receive any response superior to or matching any of its offers.

6. The method as claimed in claim 1 wherein responses that accept all the attributes of any offer are binding on the offering party to the extent of the public offer made by the offering party.

7. The method as claimed in claim 1 wherein the offering party or the counterparty can withdraw the remainder of its offers after accepting a response.

8. The method as claimed in claim 1 wherein an offering party generates multiple alternate offers simultaneously.

9. The method as claimed in claim 1 wherein a counterparty responds to an offer with a response.

10. The method as claimed in claim 1 wherein a counterparty simultaneously responds to more than one public offers coming from the same or different parties.

11. The method as claimed in claim 1 wherein the offer originates from an offering party which generates a modified offer by lowering the price.

12. The method as claimed in claim 1 wherein responses that are accepted by the party originating the offer are not binding on the counterparty making the response, which is free to select any one of the accepted responses.

13. A system for enabling negotiations for resolution of e-commerce transactions involving direct interactions between an offering party (seller or buyer) and a counterparty (buyer or seller), comprising:
offer generating means for generating a public offer containing values of a defined set of attributes by the offering party to the target population of the counterparties,
offer accepting means for sending private acknowledgements of acceptance or responses containing counter offers for the offer to the offering party, by a counterparty wherever desired, and
counter offer generating means for accepting a counter offer and/or generating a revised public offer wherever necessary by the offering party or the counterparty.

14. A system as claimed in claim 13 wherein the offering parties and counterparties use computing system nodes comprising:
a bus system;
a communication unit connected to the system bus;
a memory connected to the system bus, wherein the memory includes a set of instructions, and
a control unit connected to the system bus, wherein the control unit executes the instructions in the memory for generating offers and counter offers.

15. A system as claimed in claim 13 wherein the computing system nodes are arranged over a network, the network comprising:
an offering party's node for generating an offer,
a counterparty's node for generating private acceptances or for generating counter offers, and
a communication medium interconnecting the nodes form the offering parties and counterparties.

16. A computer program product comprising computer readable program code stored on computer readable storage medium embodied therein for enabling negotiations for resolution of e-commerce transactions involving direct interactions between a party (seller or buyer) and a counterparty (buyer or seller), comprising:
computer readable program code means configured for generating a public offer containing values of a defined set of attributes by the offering party to the target population of the counterparties,
computer readable program code means configured for sending private acknowledgements of acceptance or responses containing counter offers for the offer to the offering party, by a counterparty wherever desired, and
computer readable program code means configured for accepting counter offer and/or generating a revised public offer wherever necessary by the offering party or the counterparty.

17. The computer program product as claimed in claim 16 further comprising of computer readable program code means configured for continuing the sequence of formulating private responses containing acceptances or counter offers and accepting or generating modified public offers for each case as long as the offering party and the counterparty to the case wish to continue doing so.

18. The computer program product as claimed in claim 16 wherein computer readable program code means configured for the offering party to accept counter offers inferior to its offers if the offering party does not receive any counter offer superior to or matching any of its offers.

19. The computer program product as claimed in claim 16 wherein computer readable program code means configured for withdrawal of the remainder of the offers after accepting a response to the original offer by the offering party.

20. The computer program product as claimed in claim 16 wherein computer readable program code means configured for generating multiple alternate offers simultaneously.

21. The computer program product as claimed in claim 16 wherein computer readable
program code means configured for responding to an offer with a response.

22. The computer program product as claimed in claim 16 wherein computer readable program code means configured for a counterparty to simultaneously respond to more than one public offers coming from the same or different parties.
